(19) United States
(12) Patent Application Publication
(10) Pub. No.: US 2003/0198576 A1
(43) Pub. Date: Oct. 23, 2003

(54) Ratiometric dilution devices and methods

(75) Inventors: Courtney L. Coyne, Pasadena, CA (US); Leanna M. Levine, Redondo Beach, CA (US); Adrian Hightower, Pasadena, CA (US); Marci Pezzuto, Altadena, CA (US); Christoph D. Karp, Pasadena, CA (US); Steven E. Hobbs, West Hills, CA (US); Terence T. Flynn, Altadena, CA (US)

Correspondence Address: NANOSTREAM, INC., 580 SIERRA MADRE VILLA AVE., PASADENA, CA, 91107-2928, US

(73) Assignee: Nanostream, Inc.

(21) Appl. No.: 10/372,032

(22) Filed: Feb. 21, 2003

Related U.S. Application Data
(60) Provisional application No. 60/359,559, filed on Feb. 22, 2002.

(51) Int. Cl. G01N 1/10

(52) U.S. Cl. 422/100; 436/180

(57) ABSTRACT

Substantially sealed microfluidic devices for performing pipettorless ratiometric dilution are provided. In one embodiment, valves are disposed between and permit selective fluid communication between multiple chambers of a series of chambers. In another embodiment, a mixing chamber receives fluid from an inlet port and is in donative fluid communication with multiple receiving chambers each having a small volume than the mixing chamber. Active mixing means may be provided, including moveable magnetic elements, sonication, and mixing channels coupled with fluid transport means. A material transport system may be used with a non-electrokinetic pipettorless dilution system for transporting sample, diluent, and combinations thereof within the device.

### STATEMENT OF RELATED APPLICATION(S)

This application claims benefit of U.S. Provisional Patent Application Ser. No. 60/359,559, filed Feb. 22, 2002 and currently pending.

### FIELD OF THE INVENTION

The present invention relates to ratiometric dilution, such as is useful in various chemical or biochemical experiments or processes.

### BACKGROUND OF THE INVENTION

Various chemical or biochemical analyses or syntheses require manipulation of fluids in several different concentrations. For example, in developing pharmaceuticals it is desirable to determine the activity of one component at various concentrations mixed with fixed concentrations of other component, such as to generate a dose-response relationship.

Ratiometric dilution describes the process involved in generating multiple different concentrations of a particular mixture. Such dilution may be applied to fluid streams or fluid plugs. A mixture subject to ratiometric dilution typically contains a sample and a diluent. Typically, a series of six to ten or more different containers, such as wells of a microtiter plate or a series of test tubes, are used. Often, these volumetric series are prepared in duplicate or triplicate.

There are two broad methods for performing ratiometric dilutions: serial dilution and parallel dilution. Serial dilution involves a series of volumetric transfers from one container to another in a series. Each container in the series typically has a constant fixed volume. Typically, all containers in the series after the first container are initially filled with an initial volume Vₒ of diluent. A volume of sample equal to Vₒ plus a transfer volume Vₜ is placed into the first container. A volume Vₜ is then extracted from the first container and transferred to the second container, where it is mixed with the diluent volume Vₒ contained therein. After mixing, the same transfer volume Vₜ is extracted from the second container and deposited into the third container, where is mixed with the diluent volume Vₒ contained therein. This sequence continues in sequence until the dilution is complete. The concentration in each subsequent well is decreased by the ratio [Vₛ/(Vₒ+Vₛ)]. The last container in the series will contain a final volume equal to Vₒ plus Vₜ (unless a further extraction is performed to remove excess volume Vₜ).

Vₒ is usually some multiple of Vₜ so that the dilution series is often named by this ratio. Thus if Vₒ equals Vₜ, then the dilution is termed a 1-to-2 dilution. Commonly performed dilutions are 1-to-2, 1-to-3 and 1-to-10.

The second broad method for performing ratiometric dilution is parallel dilution, which involves the addition of a constant sample volume to multiple containers each containing a different volume of diluent. Depending on the degree of dilution desired, the volume of diluent in each container may vary dramatically—sometimes by several orders of magnitude. What typically results is a set of mixtures each having a different concentration and different volume.

Using parallel dilution, for example, a 1-to-2 dilution could be accomplished by adding a set of sample volumes (Vₛ) diluted in parallel into diluent volumes equal to 1Vₛ, 3Vₛ, 7Vₛ, 15Vₛ, 31Vₛ, 63Vₛ, 127Vₛ, 255Vₛ, 511Vₛ, and 1023Vₛ, to yield a ten fold ratiometric dilution. What results is the following series of mixture volumes: 2Vₛ, 4Vₛ, 8Vₛ, 16Vₛ, 32Vₛ, 64Vₛ, 128Vₛ, 256Vₛ, 512Vₛ, and 1024Vₛ. If the initial concentration is 1.0 molar (1.0 M), then each dilution yields the following concentrations: 0.5M, 0.25, 0.125, 0.062, 0.031, 0.016, 0.008, 0.004, 0.002, and 0.001M for a ten-fold dilution.

Serial dilution and parallel dilution have their own distinct advantages and disadvantages. It is typically desirable to use fixed volumes of ratiometrically diluted mixtures in performing further operations. One advantage to serial dilution is that it easily yields a set of fixed volume mixtures. This minimizes the number of manipulations involved in the process to yield the desired result, and conserves sample and diluent.

A primary disadvantage of serial dilution is the propagation of error. Not only does an error in the first dilution propagate throughout the dilution series, but also the percentage error gets compounded upon each transfer. The propagated error can be observed experimentally as a deviation from the theoretical dilution curve. It is most convenient to look at the log of expected concentration versus the log of the measured concentration (as determined by a spectrophotometric method) to see a deviation from linearity.

Using a parallel dilution method, the error in mixture concentrations would vary randomly around the error in metering the individual volumes of diluent and the error in metering the initial Vₜ. The resulting error would be largely determined by the error in metering Vₜ.

Despite being free of propagated error, parallel dilution is not routinely performed because it requires additional manipulation to yield a set of constant-volume mixtures and it consumes dramatically larger volumes of diluent and sample.

To incorporate the advantages and minimize the disadvantages of each method described above, a hybrid method can be employed. For example, a sample volume 2Vₜ could be split in half, with a first portion 1Vₜ used in for the first four dilutions according to a normal serial dilution method. Then, the second sample portion of volume 1Vₜ is added to a diluent volume corresponding to that which would be used in the fifth dilution using a parallel method, or 31Vₜ. Then a volume Vₜ is extracted diluted thereafter according to a normal serial dilution. If it is desired to provide constant volume mixtures of each concentration, then the surplus 30Vₜ may be subsequently removed from the container used for the fifth dilution. This hybrid method reduces propagated error as compared to using straight serial dilution. Practically speaking, however, hybrid methods such as the one just described are rarely performed because they are not amenable to automation using conventional technologies such as manual or robotic pipettors.

Each of the above-mentioned methods for performing ratiometric dilution is labor-intensive. Traditionally, serial dilution was performed manually by skilled technicians, taking considerable time and adding the potential for human error. With the introduction of robotic equipment, serial dilution has been largely automated. However, industry has not realized the purported benefits of robotic automation for small batches or for complex experiments. In the case of small batches (less than about 20), it is often more efficient to perform dilution manually than to program a machine to do the same. And in the case of complex experiments, it is difficult to control cross-contamination and maintain accuracy, let alone the difficulty of programming a machine to perform the task. Additionally, by employing straight serial dilution methods, conventional automation equipment does not alleviate problems with propagated error.

Traditionally, fluid manipulation in microfluidic devices has been controlled by electrokinetic transport (including electrophoretic and/or electroosmotic flow). These techniques involve the use of voltages and electric currents to control the movement of fluid and/or particles within that fluid. Electrodes are placed within channels and voltage is applied. Typically, this voltage is sufficient to cause hydrolysis of liquid within the device, thus producing a charge gradient throughout the channels that causes either fluid, or molecules contained within the fluid, to move. These techniques have numerous limitations including: providing conductive electrodes within the channels, connecting these electrodes to an external voltage/current source, and the fact that hydrolysis of water often causes the formation of bubbles and other radicals that may have adverse effects on the devices or fluid manipulations occurring within with the devices. Additionally, the range of useful fluids, molecules, and buffer concentrations may be limited when using electrokinetic fluid transport techniques.

In light of the above, it would be desirable to integrate ratiometric dilution functions into a self-contained fluidic device or system that would be simple to operate. Such a device would preferably be substantially sealed to reduce undesirable evaporation. Preferably, such a device or system would yield high accuracy at low volumes and be capable of performing complex fluid manipulation to automate experiments. Such a device or system would preferably be non-electrokinetic. Further preferably, a microfluidic device would interface with conventional laboratory equipment, including manual or robotic (input) pipettors and detection instruments.

### BRIEF DESCRIPTION OF THE DRAWINGS

FIG. 1A is an exploded perspective view of a first ratiometric dilution device constructed from seven layers. FIG. 1B is a top view of the assembled device of FIG. 1A. FIG. 1C is a top view of the second layer of the device of FIGS. 1A-1B. FIG. 1D is a top view of three superimposed layers, namely, the fourth, fifth, and sixth layers, of the device of FIGS. 1A-1B. FIG. 1E is a top view of a mask useful for constructing (more specifically, for patterning a substance onto specific regions of at least one layer of) the device of FIGS. 1A-1B.

FIGS. 2A-2H are sequential schematic views of a portion of the device of FIGS. 1A-1B operating to combine and mix fluids initially contained in two separate chambers.

FIG. 3A is an exploded perspective view of a second ratiometric dilution device constructed from seven layers. FIG. 3B is a top view of the assembled device of FIG. 3A. FIG. 3C is a top view of the fourth layer of the device of FIGS. 3A-3B.

FIGS. 4A-4B are sectional views of a microfluidic barrier valve in two different states of operation.

FIG. 5 is a schematic view of a system for operating a ratiometric dilution device.

FIG. 6 is a flow diagram showing the steps of a first ratiometric dilution method such as may be used with a device according to the design of FIGS. 1A-1D.

FIG. 7 is a flow diagram showing the steps of a second ratiometric dilution method such as may be used with a device according to the design of FIGS. 3A-3C.

### DETAILED DESCRIPTION OF PREFERRED EMBODIMENTS OF THE INVENTION

Definitions

The term “microfluidic” as used herein refers to structures or devices through which one or more fluids are capable of being passed or directed and having at least one dimension less than about 500 microns.

The term “pipettorless dilution” as used herein refers to dilution without the use of pipettors to mix fluids, or to extract fluid from one region of a device and deposit to another region. The term is intended, however, to encompass dilution within a substantially sealed device without regard to the means for initial delivery fluid volume(s) to the device. Thus, pipettorless dilution as referred to herein could utilize a pipettor for initial delivery of one or more fluid volumes to a microfluidic device.

The term “stencil” as used herein refers to a material layer or sheet that is preferably substantially planar through which one or more variously shaped and oriented portions have been cut or otherwise removed through the entire thickness of the layer, and that permits substantial fluid movement within the layer (e.g., in the form of channels or chambers, as opposed to simple through-holes for transmitting fluid through one layer to another layer). The outlines of the cut or otherwise removed portions form the lateral boundaries of microstructures that are formed when a stencil is sandwiched between other layers such as substrates or other stencils.

The term “substantially sealed” as used herein refers to the condition of being substantially enclosed to reduce undesirable fluid evaporation, and, preferably, substantially free of unintended leakage. The term encompasses devices having one or more fluidic ports for communicating fluids to or from the devices, such as by using a pipettor or other means.

Microfluidic Device Fabrication

Ratiometric dilution methods according to the present invention may be performed in microfluidic devices of various designs and built with different fabrication techniques. In an especially preferred embodiment, microfluidic dilution devices are constructed using stencil layers or sheets to define channels and/or other microstructures. For example, a computer-controlled plotter modified to accept a cutting blade may be used to cut various patterns through a material layer. Such a blade may be used either to cut sections to be detached and removed from the stencil layer or to fashion slits that separate certain regions of a layer without removing any material. Alternatively, a computer-controlled laser cutter may be sued to cut portions through a material layer. While laser cutting may be used to yield precisely-dimensioned microstructures, the use of a laser to cut a stencil layer inherently involves the removal of some material. Further examples of methods that may be employed to form stencil layers include conventional stamping or die-cutting technologies. The above-mentioned methods for cutting through a stencil layer or sheet permits robust devices to be fabricated quickly and inexpensively compared to conventional surface micromachining or material deposition techniques that are conventionally employed to produce microfluidic devices.

After a portion of a stencil layer is cut or removed, the outlines of the cut or otherwise removed portions form the lateral boundaries of microstructures that are completed upon sandwiching a stencil between substrates and/or other stencils. The thickness or height of the microstructures such as channels or chambers can be varied by altering the thickness of the stencil layer, or by using multiple substantially identical stencil layers stacked on top of one another. When assembled in a microfluidic device, the top and bottom surfaces of stencil layers are intended to mate with one or more adjacent layers (such as stencil layers or substrate layers) to form a substantially enclosed device, typically having at least one fluidic inlet port and often having at least one fluidic outlet port.

Various means may be used to seal or bond layers of a device together. For example, adhesives may be used. In a preferred embodiment, one or more layers of a device may be fabricated from single- or double-sided adhesive tape, although other methods of adhering stencil layers may be used. A portion of the tape (of the desired shape and dimensions) can be cut and removed to form channels, chambers, and/or apertures. A tape stencil can then be placed on a supporting substrate with an appropriate cover layer, between layers of tape, or between layers of other materials. In one embodiment, stencil layers can be stacked on each other. In this embodiment, the thickness or height of the channels within a particular stencil layer can be varied by varying the thickness of the stencil layer (e.g., the tape carrier and the adhesive material thereon) or by using multiple substantially identical stencil layers stacked on top of one another. Various types of tape may be used with such an embodiment. Suitable tape carrier materials include but are not limited to polyesters, polycarbonates, polytetrafluoroethlyenes, polypropylenes, and polyimides. Such tapes may have various methods of curing, including curing by pressure, temperature, or chemical or optical interaction. The thickness of these carrier materials and adhesives may be varied.

Notably, stencil-based fabrication methods enable very rapid fabrication of devices, both for prototyping and for high-volume production. Rapid prototyping is invaluable for trying and optimizing new device designs, since designs may be quickly implemented, tested, and (if necessary) modified and further tested to achieve a desired result. The ability to prototype devices quickly with stencil fabrication methods also permits many different variants of a particular design to be tested and evaluated concurrently.

Various means may be used to seal or bond layers of a device together. For example, adhesives may be used. In one embodiment, one or more layers of a device may be fabricated from single- or double-sided adhesive tape, although other methods of adhering stencil layers may be used. A portion of the tape (of the desired shape and dimensions) can be cut and removed to form channels, chambers, and/or apertures. A tape stencil can then be placed on a supporting substrate with an appropriate cover layer, between layers of tape, or between layers of other materials. In one embodiment, stencil layers can be stacked on each other. In this embodiment, the thickness or height of the channels within a particular stencil layer can be varied by varying the thickness of the stencil layer (e.g., the tape carrier and the adhesive material thereon) or by using multiple substantially identical stencil layers stacked on top of one another. Various types of tape may be used with such an embodiment. Suitable tape carrier materials include but are not limited to polyesters, polycarbonates, polytetrafluoroethlyenes, polypropylenes, and polyimides. Such tapes may have various methods of curing, including curing by pressure, temperature, or chemical or optical interaction. The thicknesses of these carrier materials and adhesives may be varied.

In another embodiment, device layers may be directly bonded without using adhesives to provide high bond strength (which is especially desirable for high-pressure applications) and eliminate potential compatibility problems between such adhesives and solvents and/or samples. Specific examples of methods for directly bonding layers of unoriented polyolefins such as unoriented polypropylene to form stencil-based microfluidic structures are disclosed in co-pending U.S. patent application Ser. No. 10/313,231 (filed Dec. 6, 2002), which is owned by assignee of the present application and incorporated by reference as if fully set forth herein. In one embodiment, multiple layers of 7.5-mil (188 micron) thickness “Clear Tear Seal” polypropylene (American Profol, Cedar Rapids, Iowa) including at least one stencil layer may be stacked together, placed between glass platens and compressed to apply a pressure of 0.26 psi (1.79 kPa) to the layered stack, and then heated in an industrial oven for a period of approximately 5 hours at a temperature of 154° C. to yield a permanently bonded microstructure well-suited for use with high-pressure column packing methods. In another embodiment, multiple layers of 7.5-mil (188 micron) thickness “Clear Tear Seal” polypropylene (American Profol, Cedar Rapids, Iowa) including at least one stencil layer may be stacked together. Several microfluidic device assemblies may be stacked together, with a thin foil disposed between each device. The stack may then be placed between insulating platens, heated at 152° C. for about 5 hours, cooled with a forced flow of ambient air for at least about 30 minutes, heated again at 146° C. for about 15 hours, and then cooled in a manner identical to the first cooling step. During each heating step, a pressure of about 0.37 psi (2.55 kPa) is applied to the microfluidic devices.

Notably, stencil-based fabrication methods enable very rapid fabrication of devices, both for prototyping and for high-volume production. Rapid prototyping is invaluable for trying and optimizing new device designs, since designs may be quickly implemented, tested, and (if necessary) modified and further tested to achieve a desired result. The ability to prototype devices quickly with stencil fabrication methods also permits many different variants of a particular design to be tested and evaluated concurrently.

In further embodiments, microfluidic devices for performing ratiometric dilution according to the present invention may be fabricated from materials such as glass, silicon, silicon nitride, quartz, or similar materials. Various conventional machining or micromachining techniques such as those known in the semiconductor industry may be used to fashion channels, vias, and/or chambers in these materials. For example, techniques including wet or dry etching and laser ablation may be used. Using such techniques, channels, chambers, and/or apertures may be made into one or more surfaces of a material or penetrate through a material.

Still further embodiments may be fabricated from various materials using well-known techniques such as embossing, stamping, molding, and soft lithography.

In addition to the bonding methods discussed above, other techniques may be used to attach one or more of the various layers of microfluidic devices, as would be recognized by one of ordinary skill in attaching materials. For example, attachment techniques including thermal, chemical, or light-activated bonding steps; mechanical attachment (such as using clamps or screws to apply pressure to the layers); and/or other equivalent coupling methods may be used.

First Preferred Fluidic Device

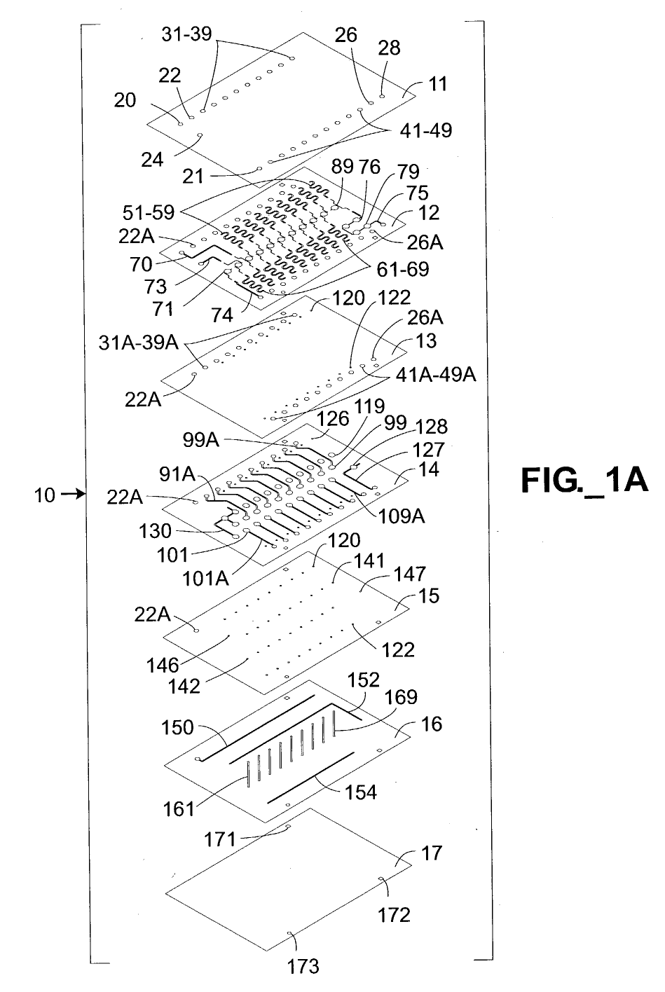

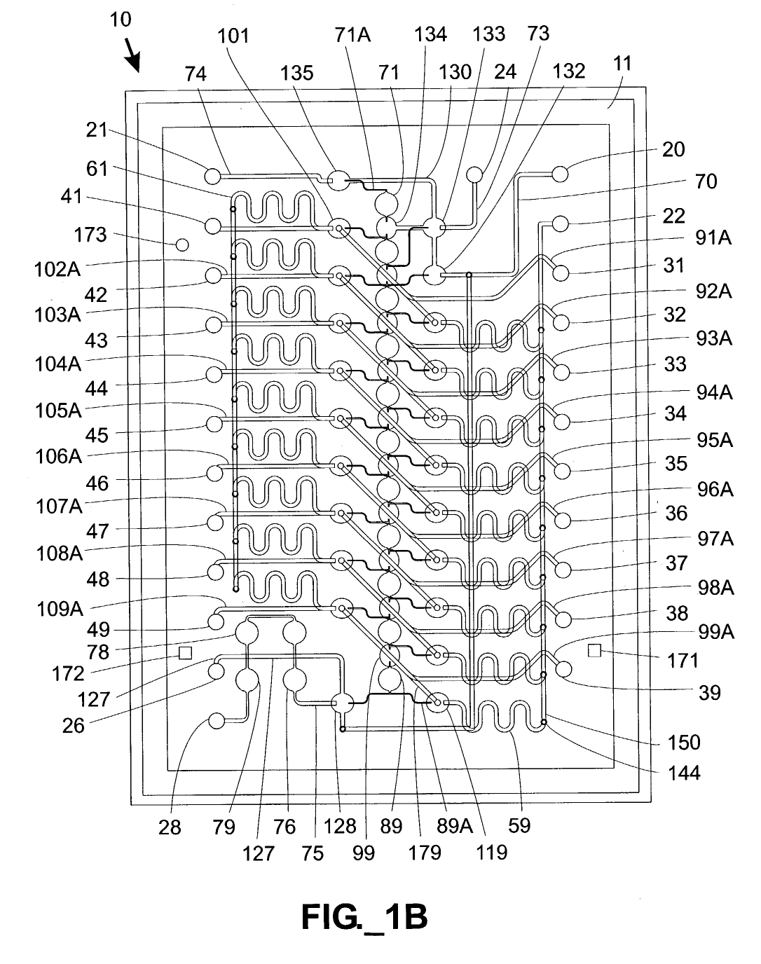

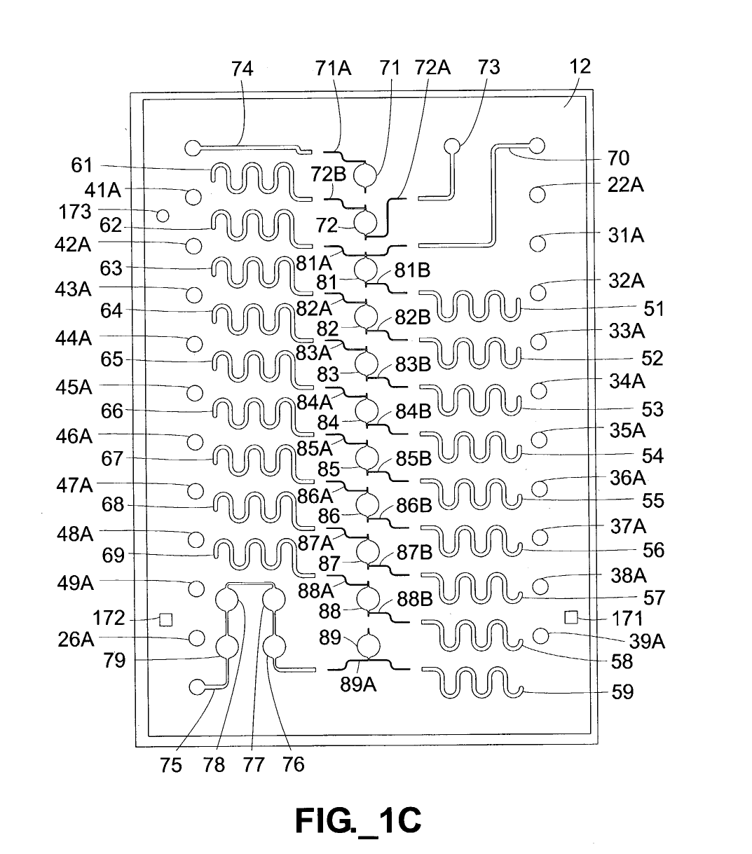

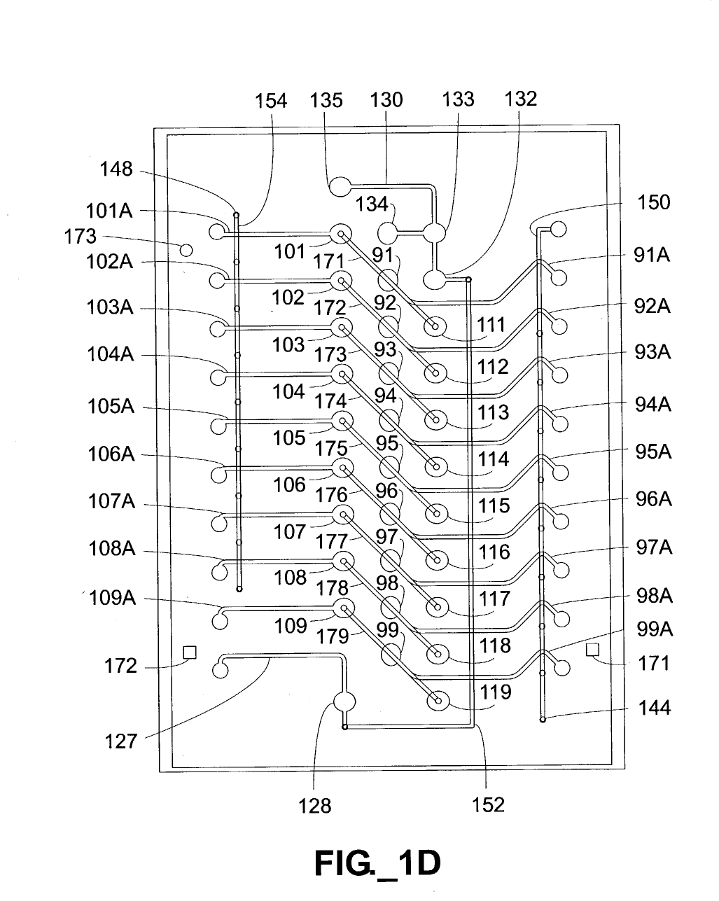

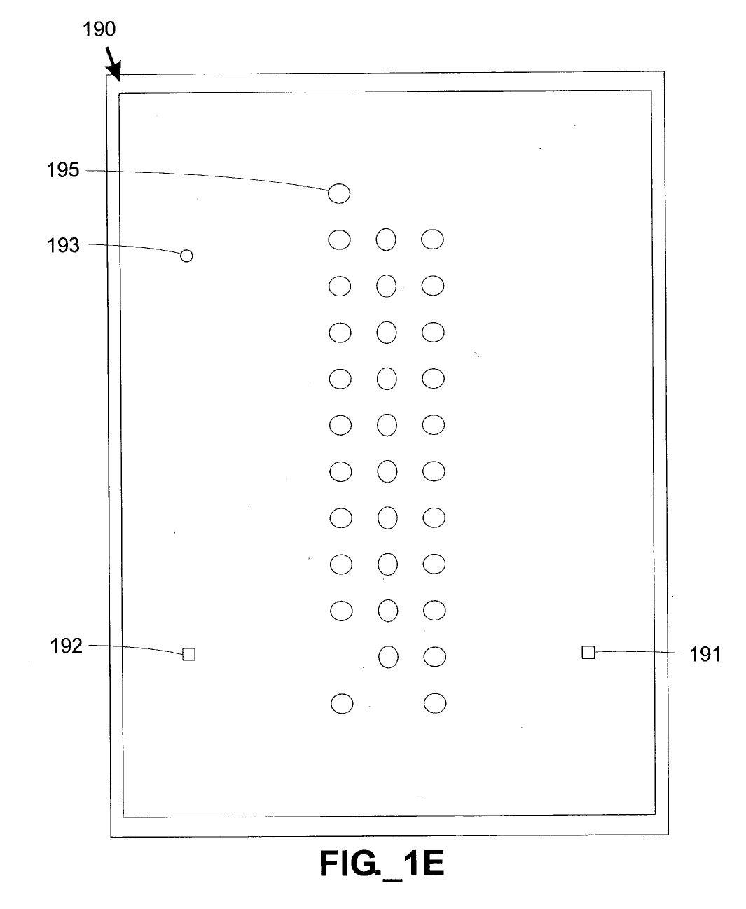

A first preferred microfluidic device for performing ratiometric dilution is illustrated in FIGS. 1A-1D. While various materials and microstructure dimensions may be used, what follows is one example including specific materials and dimensions. The device 10 is constructed from seven layers 11-17, including stencil layers 12, 14, and 16. The first layer 11, an acrylic substrate, 62.5 mils (1.56 mm) thick, defines a number of different apertures: a diluent inlet port 20, sample inlet port 21, a mixer vent 22, a sample outlet port 24, a containment valve actuation port 26, a diluent outlet port 28, nine inter-chamber valve actuation ports 31-39, and nine mixing valve actuation ports 41-49. Several of these apertures have corresponding vias defined in layers below the first layer 11. For example, vias 31A-39A and 41A-49A in fluid communication with actuation ports 31-39 and 41-49, respectively, are defined in both the second and third layers 12, 13. Further defined in the second and third layers 12, 13 are vias 26A in fluid communication with the containment valve 26 defined in the first layer 11. The second through fifth layers 12-15 define vias 22A in fluid communication with the mixer vent 22 to ventilate the channel 150 defined in the sixth layer 16. Notably, the second through seventh layers 12-17 also define alignment holes 171-173 to assist in aligning device layers during assembly. Preferably, fixed alignment pins (not shown) conforming to the size and spacing of the alignment holes 171-173 are used to promote precise alignment between layers.

The second, fourth, and sixth stencil layers 12,14, 16 are constructed from 5.8 mil (147 microns) thick double-sided tape (FT 445, Avery Dennison, Pasadena, Calif.) comprising a 1 mil (25 microns) thick polypropylene carrier and a 2.4 mil (61 microns) thick rubber adhesive layer on each side. The second layer 12 (illustrated in detail in FIG. 1C) is the primary fluid layer since, when in use, it contains both sample and diluent. A diluent inlet channel 70 defined in the second layer 12 is in fluid communication with the diluent inlet port 20 defined in the first layer 11. Similarly, the second layer 12 defines a sample outlet channel 73 in fluid communication with the sample outlet port 24. A diluent outlet channel 75 having four associated optical reference chambers 76-79 is further defined in the second layer 12. Several additional chambers are defined in the second layer 12; specifically, sample chambers 71, 72, and dilution chambers 81-89. Each of these chambers 71, 72, 81-89 has at least one associated narrow channel, namely: channel 71A associated with chamber 71; channels 71A-71B associated with chamber 72; similarly, channels 81A-88B associated with chambers 81-88 of like numbers; and channel 89A associated with chamber 89. Additionally, nine pairs of mixing channels (51, 61; 52, 62; 53, 63; 54, 64; 55, 65; 56, 66; 57, 67; 58, 68; and 59, 69) are defined in the second layer 12, with each mixing channel pair associated with one pair of adjacent chambers 72, 81-89. For example, the first mixing channel pair 51, 61 is associated with chambers 72, 81; the second mixing channel pair 52, 62 is associated with chambers 81, 82; the third mixing channel pair 53, 63 is associated with chambers 82, 83; and so on, continuing to the ninth mixing channel pair 59, 59, which are associated with adjacent dilution chambers 88, 89.

Regarding dimensions, the channels in the second layer 12 are generally about 30 mils (762 microns) wide, except for the narrow channels 71A, 72A-72B, 81A-88B, 89A, which are about 15 mils (381 microns) wide. The chambers 71, 72, 81-89, 75-78 are each about 135 mils (3.4 mm) in diameter.

Notably, there exist gaps or barriers between various microstructures defined through the second layer 12 where material has not been removed. These barriers separate various microstructures and are integral portions of actuatable “barrier valves” described in further detail herein. Gaps are present, for example, between adjacent chambers (e.g., chambers 71, 72; chambers 72, 81; and so on); between mixing channels and adjacent narrow channels (e.g., mixing channel 61 and narrow channel 72B; mixing channel 51 and narrow channel 81B; mixing channel 62 and narrow channel 81A; and so on); and between inlet channels and narrow channels (e.g., diluent inlet channel 70 and narrow channel 81A; sample outlet channel 73 and narrow channel 72A; and sample inlet channel 74 and narrow channel 71A). Each of these gaps spans about 50 mils (1.3 mm). A valve actuating region (e.g., regions 91-99, 101-109, 111-119, and 132-135 shown in FIG. 1D) is provided along each such gap to permit operation of each barrier valve. (For the sake of convenience, the element number for each valve actuating region 91-99, 101-109, 111-119, and 132-135 will be treated as synonymous with the corresponding barrier valve (e.g., barrier valves 91-99, 101-109, 111-119, and 132-135.)

The third layer 13 is constructed from 0.8 mil (20 microns) thick polypropylene film (RL5000800600500′-850H, Plastic Suppliers, Columbus, Ohio). The third layer 13 defines multiple ‘large’ vias—each about 90 mils (2.3 mm) in diameter—namely, vias 22A, 26A, 31A-39A, and 41A-49A. The third through fifth layers 13 and the fourth layer 14 define two sets each of nine ‘small’ vias 120 and 122. These small vias 120, 122 are each about 40 mils (1.0 mm) in diameter. The small vias 120 provide fluid communication between the mixing channels 51-59 and the mixing channels 51-59 by way of a mixing actuation channel 150 defined in the sixth layer 16. The small vias 122 provide fluid communication between the mixing channels 61-69 and an interconnect channel 154 defined in the sixth layer 16. The combined volume of the interconnected mixing channels 61-69 and the interconnect channel 154 is permits air to be compressed ahead of an advancing liquid front in any of the mixing channels 61-69. While a vent (not shown) could be substituted for the interconnected channel 154 and mixing channels 61-69, the illustrated design is preferred.

The fourth through sixth layers 14-16 define microstructures used to promote and/or control fluid movement in the second layer 12. For example, pressurized fluid (preferably a gas such as pressurized air or nitrogen) and vacuum may be selectively applied to the fourth through sixth layers 14-16 to selectively open or close fluid paths in the second layer 12.

The fourth layer 14 defines nine inter-chamber valve channels 91A-99A each having a correspondingly-numbered oversized terminal end (e.g., terminal ends 91-99) to actuate barrier valve regions between the chambers 72, 81-89 defined in the second layer 12. Also defined in the fourth layer 14 are nine mixing valve channels 101A-109A each having a correspondingly-numbered oversized terminal (valve) end (e.g., terminal ends 101-109). Nine mixing valve apertures 111-119 defined in the fourth layer 14 are also associated with the mixing valve channels 101A-109A by way of connecting channels 161-169 defined in the sixth layer 16 and two sets of vias 141-142 defined in the fifth layer 15. That is, actuation of any mixing valve channel 101A-109A operates two regions: a terminal end 101-109 and a corresponding mixing valve aperture 111-119. The fourth layer 14 further defines a first containment valve channel segment 127 having an oversized valve region 128, and a second, related containment valve channel segment 130 having four oversized valve regions 132-135. Fluid communication between the two containment valve channel segments 127,130 is provided by way vias 141, 146 and an intermediate containment channel 152 defined in the sixth layer 16. The channels defined layer in the fourth layer 14 are all about 30 mils (762 mils) wide, and the terminal ends 101-109 and apertures 111-119 are each elliptical in shape with dimensions of 120 mils (3.0 mm)×110 mils (2.8 mm).

The fifth layer 15 is constructed from 5.0 mil (127 microns) thick polyester film (RIA305000600500′, Plastic Suppliers, Columbus, Ohio). The fifth layer 15 defines four sets of small vias 120,122,141, and 142, two individual small vias 146, 147, and one large via 146. As before, the large via 146 is about 90 mils (2.3 mm) in diameter, and the small vias 120,122, 141, 142, 146, 147 are each about 40 mils (1.0 mm) in diameter.

The sixth layer 16 defines nine connecting channels 161-169 that connect the terminal ends 101-109 of the mixing valve channels 101A-109A with the corresponding mixing valve apertures 111-119, all defined in the fourth layer 14. As discussed previously, the sixth layer 16 also defines an intermediate containment channel 152, a mixing actuation channel 150, and interconnect channel 154. The channels defined in the sixth layer 16 are each about 30 mils (762 microns) wide.

The seventh layer 17 serves as a cover, providing the lower boundary for the channels 150, 152, 154, and 161-169 defined in the sixth layer. The seventh layer 17 is constructed from 2.0 mil (51 microns) thick polyester film (RIA202000600500, Plastic Suppliers, Columbus, Ohio).

After the seven layers 11-17 are constructed, preferably the first layer 11 and the second layer 12 are aligned and adhered together. After this first step, one or more substances to prevent adhesion are deposited in specific regions along either the lower surface of the (self-adhesive) second layer 12 or (less preferably) along the upper surface of the third layer 13 to locally prevent bonding between the layers in those regions so as to permit operation of barrier valves. Examples of substances for preventing adhesion include: oil-form poly(hexafluoropropylene oxide) grease thickened with low molecular weight poly(tetrafluoroethylene), such as Krytox® grease (DuPont Performance Lubricants, Wilmington, Del.); aerosol dry film PTFE (polytetrafluoroethylene) mold release (Sherwin-Williams, Solon, Ohio); and powdered magnesium silicate hydroxide (Mg₃Si₄O₁₀(OH)₂). Deposition of such materials may be aided by using a mask. A mask may be constructed from a material that will not permanently bond with the second or third layers of the device. A preferred mask material is a liner supplied with a self-adhesive tape, such as the liner supplied with FT 445 double-sided adhesive tape (Avery Dennison, Pasadena, Calif.). The liner may be cut to form apertures in the same manner as any stencil layer is formed.

Regions where the adhesion-preventing substance are applied correlate to the chambers or regions 91-99, 101-109, 111-119, 128, and 132-135. The particular deposition technique to be employed depends on the substance used. For application of a substantially non-spreading material such as an aerosol or powder, a mask such as the mask 190 illustrated in FIG. 1E may be used to aid in patterning the substance in particular regions. The unmasked (cut-out) regions 195 in the mask 190 roughly correspond in size and shape to the chambers or regions 91-99, 101-109, 111-119, 128, 132-135 illustrated in FIGS. 1A, 1B, 1D. The mask may define alignment holds 191-193 corresponding to the holes 171-173 in various layers of the dilution device 10 to aid in aligning the mask 190 a layer of the device 10. If an aerosol dry film PTFE (polytetrafluoroethylene) mold release (Sherwin-Williams, Solon, Ohio) is used, then it is preferably applied in multiple passes through the mask 190 from a distance of about ten inches (25 cm). If a powder such as magnesium silicate hydroxide is used, it may be applied through the same mask 190, with any excess powder subsequently shaken from the surface. If a PTFE-thickened grease is used, however, then the unmasked regions are preferably smaller because the grease tends to spread upon sandwiching of the device layers 11-17. Dabs of PTFE-thickened grease may be applied to the mask adjacent to the unmasked regions and then manually dragged, such as by using a squeegee, into the unmasked regions. After the adhesion-preventing substance is applied in the desired regions, the mask is removed.

Following application of the adhesion-preventing substance, the remaining device layers are preferably assembled in the following order. The fourth layer 14 is adhered to the third layer 13. Then the combined third and fourth layers 13, 14 are bonded to the paired first and second layers 11, 12. Thereafter, the fifth, sixth, and seventh layers 15, 16, 17 are each applied in order.

Preferably, the chambers 71, 72, 81-89, 76-79 of the device 10 are sized, shaped, and positioned to conform to wells arrayed in a standard 96, 384, or 1536 well plate format. Additionally, these chambers are preferably bounded on at least one surface by a substantially optically transmissive material. These two features permit the results of dilution on the device 10 to be reach (and quantified) optically by an optical detection device such as a plate reader. Further, the volume of each of the chambers 71, 72, 81-89, 76-79 is preferably less than or equal to about 1 microliter.

Operation of the device 10 includes filling two chambers 71, 72 with sample, and filling nine chambers 81-89 (along with chambers 75-78) with diluent. During the filling step, all mixing valve actuation ports 41-49 are closed by applying pressure (e.g., air or nitrogen pressurized to about 15 psi (103 kPa)) to prevent sample or diluent from flowing into the mixing channels 51-59 and 61-69. A first inter-chamber valve separating the chambers 72, 81 is closed by applying pressure to the first inter-chamber valve actuation port 31, thus isolating chambers 71, 72, from chambers 81-89. The containment valves are opened by applying vacuum to the containment valve actuation port 26. The remaining inter-chamber valves are similarly opened by applying vacuum to inter-chamber valve actuation ports 32-39.

Sample and diluent are then added to the device 10. Sample is injected into the sample inlet port 21 until it fills the chambers 71, 72, with the excess flowing through the sample outlet port 24. The sample provided to chamber 71 is preserved without dilution. This is desirable to provide a reference against which further dilutions may be compared. Diluent is injected into the diluent inlet port 20 until if fills chambers 81-89 and 75-78, with excess diluent exiting the device 10 through the diluent outlet port 28.

Next, all of chambers 71, 72, 81-89 are isolated by closing the inter-chamber valves and the containment valves. This is accomplished by sequentially applying pressure to the inter-chamber valve actuation ports 32-39 followed by containment valve actuation port 26.

The dilution process proceeds generally by establishing fluid communication between two adjacent chambers, then mixing their contents together, and isolating the resulting mixture into two portions. The upstream portion is preserved, and the downstream portion is subsequently mixed with additional diluent in the next dilution.

To accomplish the first dilution, vacuum is applied to the first inter-chamber valve actuation port 31 to open a fluid path between the chambers 72, 81. Next, vacuum is applied to the first mixing valve actuation port 41 to open a fluid path between the chambers 72, 81 and the mixing channels 51, 61. The fluid contents of the chambers 72, 81 are now ready to be mixed.

Mixing generally proceeds by moving the fluids back and forth through a path having multiple contraction and expansion regions. For example, the mixing path established for the chambers 72, 81 includes mixing channel 61, narrow channel 72B, chambers 72, 81, narrow channel 80B, and mixing channel 51. The mixing path also includes fluid flow past four barrier regions between those elements. An alternating pressure differential created by operating a reversible mixing pump (such as a syringe pump) provides back-and-forth movement of the fluids through the mixing path. Communication between the reversible mixing pump and the fluids to be mixed is provide through mixing port 22.

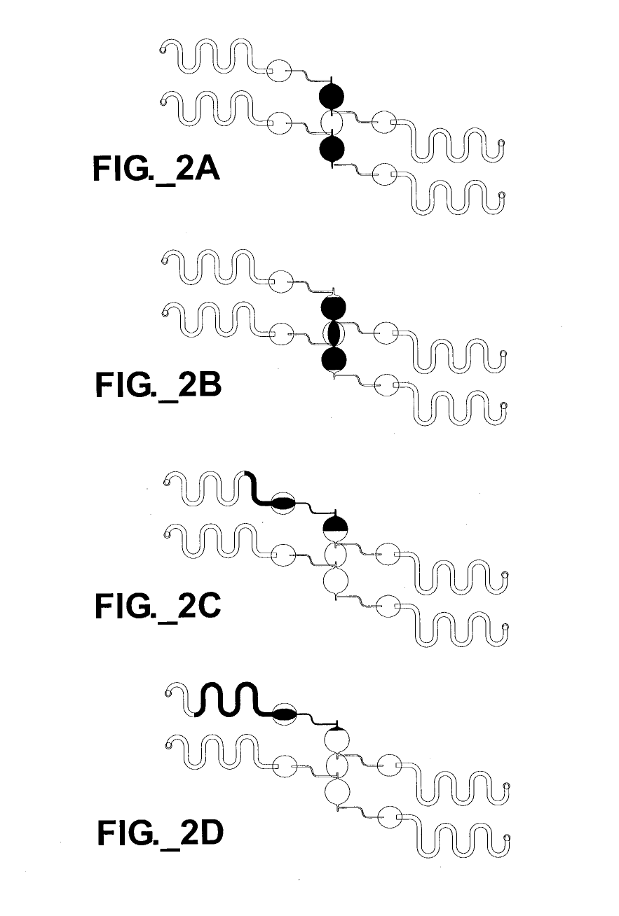

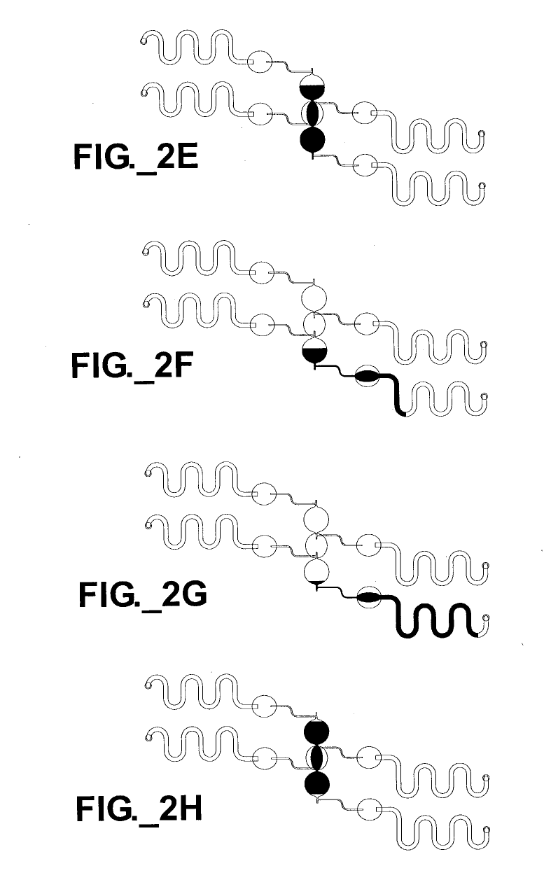

FIGS. 2A-2H illustrate fluid movement to promote mixing. FIG. 2A shows fluids contained in isolated chambers before the inter-chamber valve is opened. FIG. 2B shows the effect of opening the inter-chamber valve—namely, some fluid is drawn into the valve area along the barrier due the application of vacuum. In FIGS. 2C-2D, the fluids move through the upper chamber into the upper left mixing channel. In FIG. 2E, the direction of the mixing pressure differential is reversed and the fluids are drawn downward into the lower chamber. In FIGS. 2F-2G, the fluids move through the lower chamber into the lower right mixing channel. In FIG. 2H, the flow direction has been reversed and the fluids re-enter the chambers and inter-chamber valve region. This process may be repeated as necessary to ensure complete mixing of the fluids. Preferably, care should be exercised to prevent the mixture from reaching the outer ends of the mixing channels (and entering channels 150, 154). When mixing is complete, it is desirable to return the mixture to the position illustrated in FIG. 2H. Then, the valves associated with the mixing circuit—namely, the inter-chamber valve between the chambers whose contents have been mixed and the mixing valve associated with those chambers—are closed by pressurizing their corresponding actuation ports (e.g., actuating ports 31, 41 for chambers 72, 81).

To accomplish the second dilution, vacuum is applied to the second inter-chamber valve actuation port 32 to open a fluid path between the chambers 81, 82. Next, vacuum is applied to the first mixing valve actuation port 42 to open a fluid path between the chambers 81, 82 and the mixing channels 52, 62. The fluid contents of the chambers 81, 82 are now ready to be mixed according to the above-mentioned procedure.

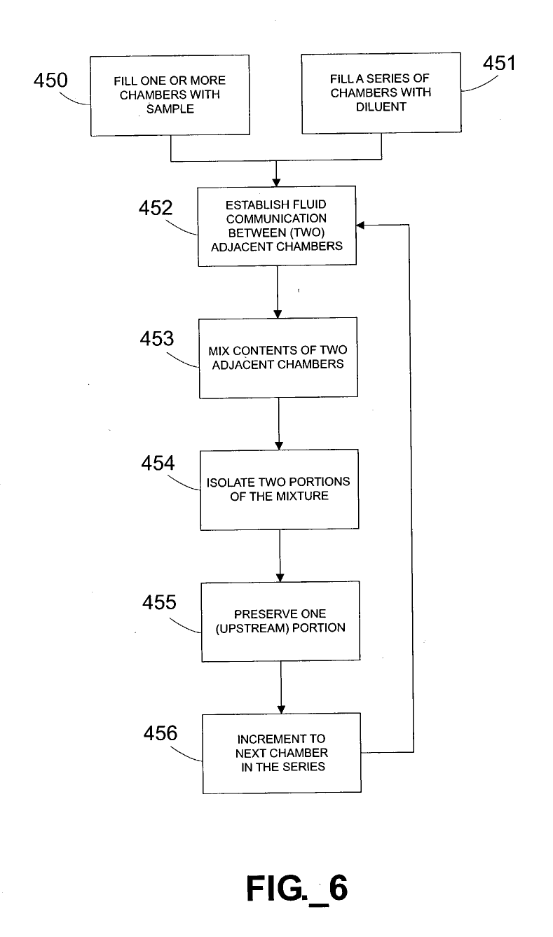

The steps of: (1) establishing fluid communication between two adjacent chambers; (2) mixing their contents together; (3) isolating the resulting mixture into two portions; and (4) preserving the upstream portion are repeated for the remaining chambers until the chambers 72, 81-88 contain nine different dilutions. Notably, the fluid contents of the chambers 88, 89 have the same concentration. A flow diagram showing the sequence of performing the above-mentioned ratiometric dilution steps 450-456 is provided in FIG. 6.

Second Preferred Fluidic Device

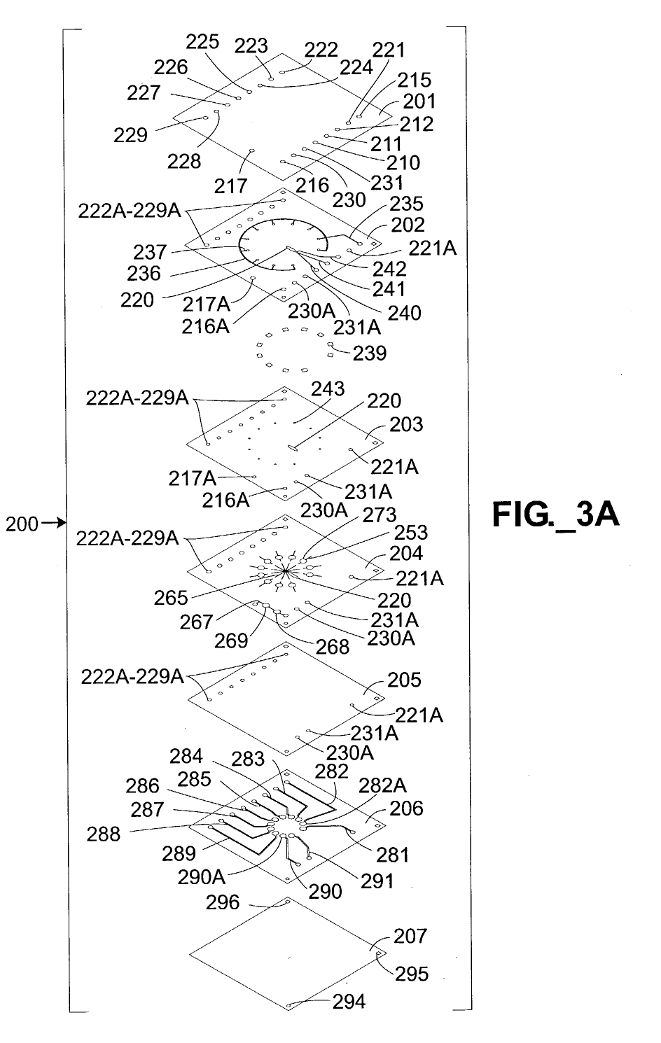

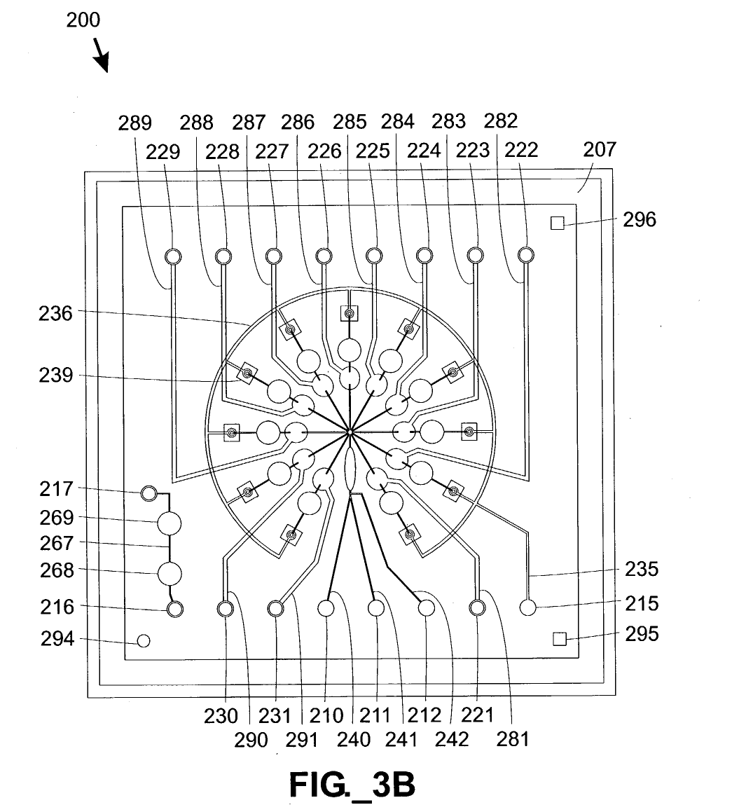

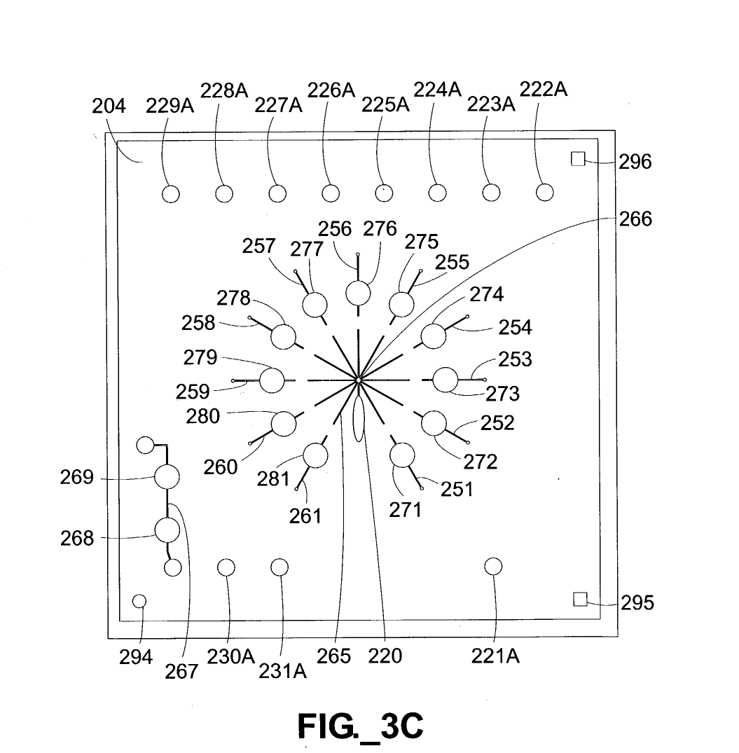

A second preferred microfluidic device for performing ratiometric dilution is illustrated in FIGS. 3A-3C. The device 200 is constructed from seven layers 201-207, including stencil layers 202, 203, 204, 206. The first layer 202, which is constructed from a 62 mil (1575 microns) thick polycarbonate substrate (Commercial Plastics, Gardena, Calif.), defines a sample inlet port 210, a diluent inlet port 211, a waste port 212, a vent port 215, valve actuating ports 221-231, and optical reference fluid ports 216, 217. Each port is about 90 mils (2.3 mm) in diameter.

The second, fourth, and sixth stencil layers 202, 204, 206 are constructed from 5.8 mil (147 microns) thick double-sided tape (FT 445, Avery Dennison, Pasadena, Calif.) comprising a 1 mil (25 microns) thick polypropylene carrier and a 2.4 mil (61 microns) thick rubber adhesive layer on each side. The second layer 202 defines multiple channels, namely: a sample inlet channel 240, a diluent inlet channel 241, a waste channel 242, a vent outlet channel 235, a vent manifold 236, and vent segments 237. The channels 240-242 are each about 15 mils (381 microns) wide. The manifold 236 is about 25 mils (635 microns) wide, and the vent segments 237 are about 20 mils (500 microns) wide. A mixing chamber 220 defined in the second, third, and fourth layers 202, 203, 204. The mixing chamber 220 is elliptical in shape and is about 224 mils (5.7 mm) long by about 60 mils (1.5 mm) wide. The second through fifth layers 202-205 define valve actuation vias 221A-231A. The second and third layers 202, 203 further define optical reference vias 216A, 217A. The second through seventh layers 202-207 further define alignment holes 294-296 to assist in aligning device layers during assembly. Preferably, fixed alignment pins (not shown) conforming to the size and spacing of the alignment holes 294-296 are used to promote precise alignment between layers.

Disposed between the second and third layers 202, 203 are porous regions 239 disposed below the medial ends of the vent segments 237 defined in the second layer 202. Preferably, the porous regions 239 are constructed from portions of a porous membrane that permits the passage of gas such as air but disallows the passage of liquid. One example of a porous membrane material that may be used includes 3.6 mil (91 microns) thick PTFE (e.g., Teflon®) porous material (7590002, Whatman, Clifton, N.J.) with an average pore size of 1 micron, although other (preferably thinner) materials may be used.

The third layer 203 is constructed from 4.8 mil (122 microns) thick single-sided tape (423-3, DeWAL Industries, Inc., Saunderstown, R.I.) comprising a 3 mil (76 microns) thick polyethylene carrier and a 1.8 mil (46 microns) thick acrylic adhesive layer. In addition to the vias 221A-231A, optical reference vias 216A, 217A, and mixing chamber 220, the third layer 203 also defines eleven small vias 243 disposed below the medial ends of the vent segments 237 and the porous regions 239. The small vias 243 are about 40 mils (1.0 mm) in diameter.

The fourth layer 204 (illustrated by itself in FIG. 3C) serves as the primary fluid layer of the device because, when in use, it contains the bulk of both sample and diluent in fluid chambers 271-281. Further defined in the fourth layer 204 are fluid channel segments 251-261 each associated with one fluidic receiving chamber 271-281. Each receiving chamber 271-281 is about 135 mils (3.4 mm) in diameter. Centrally disposed in the fourth layer 204 are twelve interconnected narrow channel segments 265 meeting at a junction 266. Each of the channel segments 265 is about 15 mils (381 microns) wide. One narrow channel segment 265 (about 15 mils (381 microns) wide) connects the mixing chamber 220 to the junction 266; the remaining eleven segments 265 permit fluid communication with the fluid channel segments 251-261 and fluidic chambers 271-281 upon operation of intermediate barrier valves. More specifically, a gap or barrier is present between the eleven inner segments 265 and the corresponding outer segments 251-261 to permit selective establishment of fluid flow paths. The fourth layer 204 further defines a optical reference channel 267 and associated optical reference chambers 268, 269, with these chambers also being about 135 mils (3.4 mm) in diameter.

The fifth layer 205 is constructed from 0.8 mil (20 microns) thick polypropylene film (RL5000800600500′-850H, Plastic Suppliers, Columbus, Ohio). The structures defined in the fifth layer 205 have been described above.

The sixth layer 206 defines eleven valve actuation channels 281-291 each having associated enlarged medial end 281A-291A. The medial ends 281A-291A are disposed directly below the gaps or barriers between the fluid channel segments 251-261 and fluidic receiving chambers 271-281 defined in the fourth layer 204. Each channel segment 251-261 is about 30 mils (762 microns) wide, with the enlarged medial ends 281A-291A being elliptical in shape with dimensions of 120 mils (3.0 mm)×110 mils (2.8 mm).

The seventh layer 17 serves as a cover, providing the lower boundary for the channels 281-291 defined in the sixth layer 206. The seventh layer 207 is constructed from 5.0 mil (127 microns) thick polyester film (RIA305000600500′, Plastic Suppliers, Columbus, Ohio).

The device 200 is constructed in a similar fashion as the device 10 discussed in connection with FIGS. 1A-1D. The first and second layers 201, 202 are first adhered together. Next the porous materials 239 are added and the third layer 203 is adhered to the paired first and second layers 201, 202 to encapsulate the porous regions 239. The fourth layer 204 is then added to the stack. Following addition of the fourth layer 204, an adhesion-preventing substance is added or patterned (e.g., using a mask) to the lower surface of the fourth layer 204 (or, less preferably, to the upper surface of the fifth layer 205) along the gaps or barriers between the eleven inner segments 265 and the corresponding outer segments 251-261. Thereafter, the sixth layer 206 is adhered to the fifth layer 205, and this combination is adhered to the stacked first through fourth layers 201-204. Finally, the seventh layer 207 is added.

Before the device 200 is operated, at least one barrier valve should be opened by applying vacuum to any of the actuating ports 221-231, and ports 211, 212 should be closed (e.g., with an off-board valve). To initiate operation of the device 200, a sample fluid is injected through the sample inlet port 210 to completely fill the mixing chamber 220. The sample port 210 is preferably then closed. All of the open barrier valves should then be closed by pressurizing the actuating ports 221-231. For example air or nitrogen pressurized to about 15 psi (103 kPa) may be used. Next the waste port 212 is opened to provide an air escape path ahead of advancing diluent when diluent is added. The diluent port 211 is then opened and diluent is added until any and all air in the diluent inlet channel 241 has been purged from the device 200. The waste port 212 is then closed.

A first barrier valve associated with the first fluidic chamber 271 is opened by applying vacuum to the first valve actuating port 221 and valve actuating channel 281. Diluent is added to the device 200 (though the diluent port 211) to displace a portion of the sample from the mixing chamber 220 into the first fluidic chamber 271 until the advancing fluid front reaches the porous region 239. Notably, the mixing chamber 220 has a greater volume than the first fluidic chamber 271 and its associated channel segments (e.g., for the first chamber 271, the associated channel segments include: one branch of the eleven interconnected channel branches 265, the channel segment 251, and the volume of one via 243 defined in the third layer 203). In the first step that sample is displaced from the mixing chamber 220 into the first fluid chamber 271, the first fluid chamber 271 receives pure sample without any diluent. This is desirable to provide a reference against which further dilutions may be compared. Once the advancing sample front reaches the porous region 239, the first barrier valve associated with the first fluidic chamber 271 is closed by applying pressure (e.g., gas pressurized to about 15 psi/103 kPa) to the first valve actuating port 221 and valve actuating channel 281. What results in the mixing chamber 220 is an unmixed combination of sample and diluent. Absent any deliberate action to mix the two fluids, any mixing will occur very slowly due to gradual diffusion.

Various methods may be used for more rapidly mixing the contents of the mixing chamber 220. In one embodiment, one or more moveable objects responsive to a magnetic field may be inserted into the mixing chamber 220 during assembly of the device. For example, chrome steel beads may be used, such as 1/64 inch (375 microns) diameter beads (model UBS-00 Small Parts, Inc. (Miami Lakes, Fla.). Because the moveable object(s) displace fluid, preferably the volume of the mixing chamber 220 is designed to account for their insertion. A permanent magnetic or other magnetic field generator may be placed in proximity to the device 200. The magnetic field is altered or moved to induce movement of the moveable object(s), thus causing the object(s) to move within the mixing chamber 220 and mix the fluidic contents of the chamber 220.

In another embodiment, sonication may be used to promote mixing. The device 200 may be placed into contact with an ultrasonic homogenizer. For example, a Misonix S3000 Sonicator® (including an XL3000 generator, convertor, and microplate horn) (Misonix, Inc., Farmingdale, N.Y.) may be used. Preferably, a layer of liquid such as water is maintained between the ratiometric dilution device 200 and the ultrasonic homogenizer (e.g., microplate horn). With a mixing chamber 220 having a volume of about 2 microliters, 20 kHz sonication at full power of about 600W produces substantially homogeneous mixing of the contents of the chamber 220 in a period of less than 10 seconds.

Following mixing of the contents of the mixing chamber 220, a second barrier valve associated with the second fluidic chamber 272 is opened by applying vacuum to the second valve actuating port 222 and valve actuating channel 282. Diluent is added to the though the diluent port 211 to displace a portion of the mixture (the first dilution) from the mixing chamber 220 into the second fluidic chamber 272 until the advancing fluid front reaches the porous region 239. Once the advancing mixture front reaches the porous region 239, the second barrier valve associated with the second fluidic chamber 272 is closed by pressurizing the second valve actuating port 222 and valve actuating channel 282.

If a 1:2 dilution is desired, then the volume of the mixing chamber should be about double the volume of each fluidic chamber plus its associated channel segments. Ratiometric dilutions according to other dilution ratios may be obtained by altering the relative volumes of the mixing chamber 220 and the fluidic chambers 271-281.

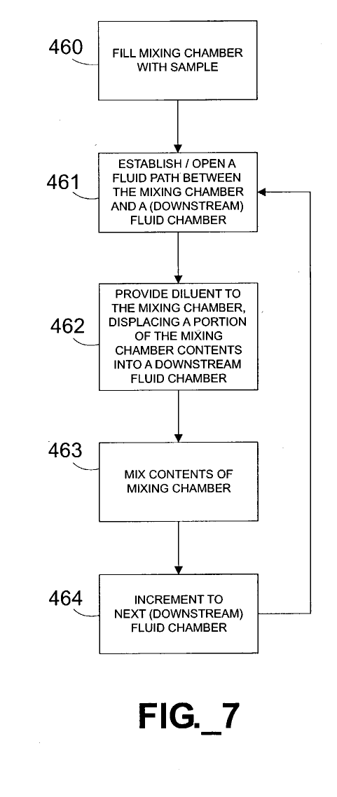

The steps of mixing the contents of the mixing chamber, then displacing a portion of the mixed contents into a fluidic chamber is repeated several times until all of the chambers 272-281 contain different dilutions (with the first chamber 271 containing pure sample). At the conclusion of the dilution, the barrier valves should all be closed. To provide an optical reference, a fluid such as diluent may be added to the chambers 268, 269 by way of ports 216, 217. A flow diagram showing the sequence of performing the above-mentioned ratiometric dilution steps 460-464 is provided in FIG. 7.

Advantages of the Preferred Fluidic Devices

The above-described preferred fluidic devices confer numerous advantages compared to dilutions performed by hand or even conventional automated pipettor equipment. For example, providing ratiometric dilution utility in an integrated microfluidic device simplifies complex dilutions, thus reducing the risk of experimenter error. Eliminating the use of pipettors further reduces the risk of cross-contamination during transfer steps.

The above-described devices allow a user to create a dilution series of a target reagent in a low volume (1 microliter or less) device, thus conserving valuable sample volume. Dilutions performed by hand at such volumes typically do not allow low-error dilutions to be performed repeatably, if at all. Discrete volumes of sample and diluent are used to perform the dilution, thus eliminating any need for a flowing system to achieve metering and mixing at each dilution.

A sample undergoing dilution in a ratiometric dilution device according to the present invention has substantially reduced exposure to the surrounding atmosphere. Therefore, such devices are well-suited for diluting reagents that are sensitive to air. Additionally, such devices minimize unintended evaporation of sample and the diluted mixtures.

Dilutions performed with ratiometric dilution devices according to designs described herein do not need to follow the traditional volumetric ratio of the sample volume. Instead, volumetric ratios can be readily varied by simply changing the dimensions of the chambers, leaving all other features constant. Such variation is practically impossible using traditional ratiometric dilution methods performed in tubes or microtiter plates with plug volumes.

System for Performing Ratiometric Dilution

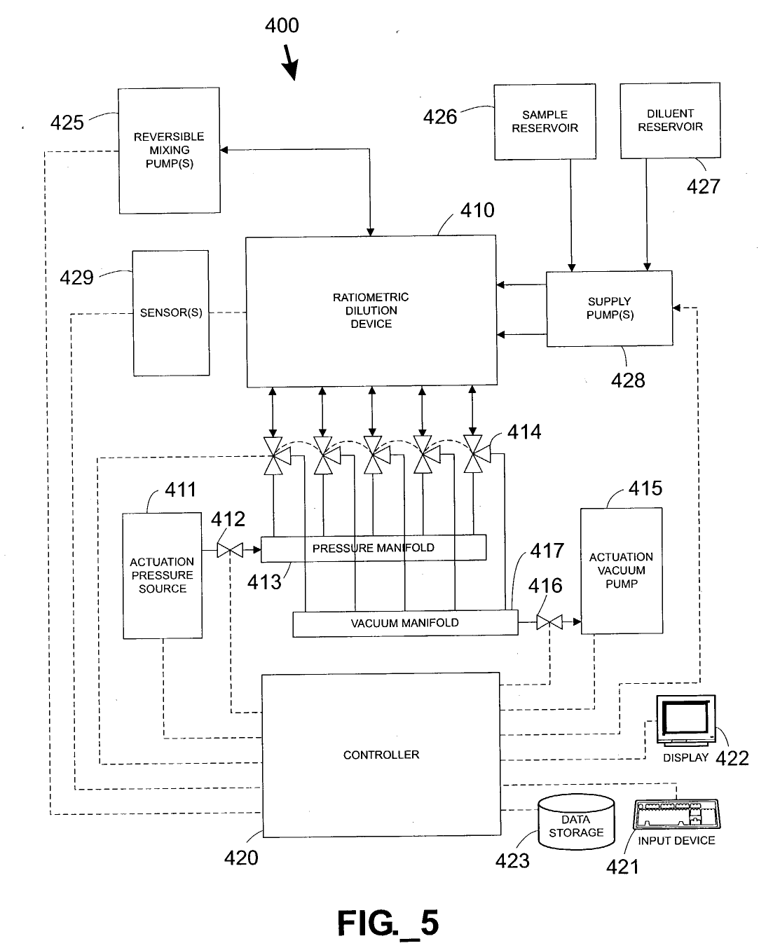

A schematic diagram of a system for performing ratiometric dilution is provided in FIG. 5. The system 400 operates a ratiometric dilution device 410, similar in design to the device 10 described in connection with FIGS. 1A-1D. Pressure and vacuum for operating actuation valves internal to the ratiometric dilution device 410 may be provided by an actuation pressure source 411 and an actuation vacuum pump 415. The actuation pressure source 411 may include components such as a compressor or a reservoir of compressed fluid, such as air or nitrogen. A pressurized fluid is preferably supplied to a pressure distribution manifold 413 by way of a first isolation valve 412. Similarly, vacuum is preferably supplied to a vacuum distribution manifold 417 by way of a second isolation valve 416. Alternating supplies of pressurized actuation fluid or vacuum may be applied to the dilution device 410 through multiple separate pressure and vacuum supply valves, or more preferably through multiple three-way valves 414. Each three-way valve 414 is individually controlled, preferably by a controller 420. While various controller types may be used, the controller 420 is preferably microprocessor-based and is capable of executing software including a sequence of user-defined instructions and/or repetitive operations. An input device 421, display 422, and data storage device 423 are preferably provided to aid in programming the controller and logging data, if any, obtained from operating the dilution device 410. The controller 420 preferably interfaces with the actuation pressure source 411, the actuation vacuum pump 415, and the isolation valves 412, 417.

One or more reversible mixing pumps 425, such as syringe pumps or other positive displacement pumps, may be used to promote back-and-forth mixing of fluids in the dilution device 410. As an alternative to a reversible pump 425, an interconnected positive pressure pump or pressure source and vacuum pump could be used. Sample and diluent may be supplied to the dilution device by way of a sample reservoir 426 and diluent reservoir 427 with one or more associated supply pumps 428. For example, a single syringe pump could be fitted with a sample syringe and a diluent syringe to supply these fluids to the device 410. As an alternative to the supply pump(s) 428, a pressure source such as a compressed nitrogen supply could pressurize the reservoir(s) to promote fluid delivery to the dilution device 410. Although the system as illustrated includes off-board sample and diluent reservoirs 426, 427, one or more of these reservoirs could be placed directly on the dilution device. Optionally, one or more sensors 429, such as, for example, pressure sensors, may be associated with the dilution device 410. Alternatively, or additionally, the sensor(s) 429 may include one or more detectors such as conventional optical or fluorescence detectors, which can be useful for detecting (among other things) the ratio of sample to diluent present in a particular chamber or other region in the fluidic device 410. Preferably, the supply pump(s) 428, mixing pump(s) 425, and sensor(s) 429 interface with the controller 420. Various components useful for transporting materials within the microfluidic device 410, such as the supply pump(s) 428, mixing pump(s) 425, actuation pressure source 411, and actuation vacuum pump 415, may be collectively termed a material transport system. External valves 414 may be optionally considered a portion of the transport system as well.

Microfluidic Barrier Valve

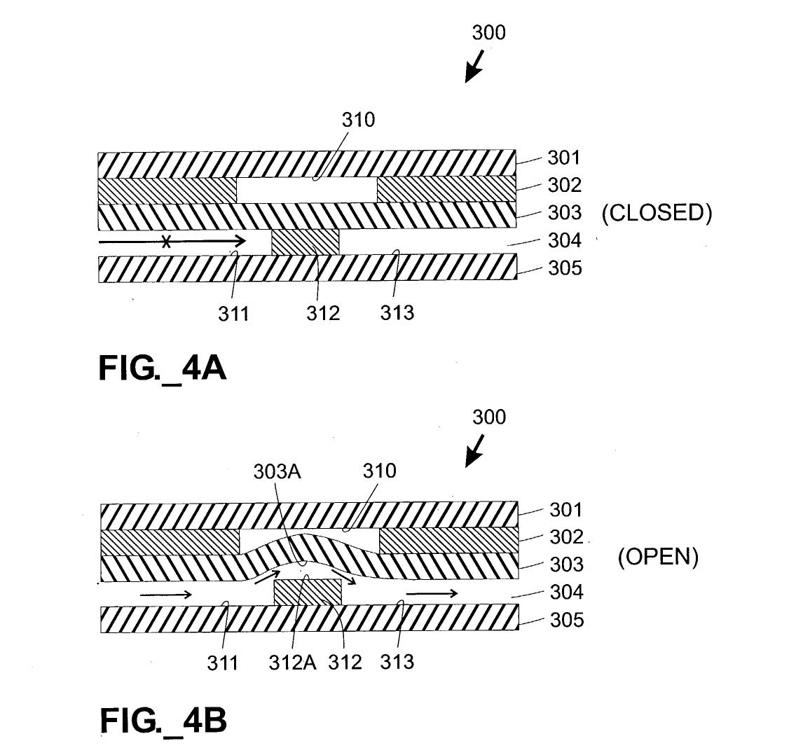

As mentioned previously, the foregoing ratiometric dilution devices 10, 200 each utilize multiple microfluidic barrier valves. These valves are particularly useful in ratiometric dilution devices because they are characterized by relatively low dead volume compared to other microfluidic valves. Sectional views of a representative barrier valve 300 in two different operating states are provided in FIGS. 4A-4B. The valve 300 is constructed in five layers 301-305 including stencil layers 302, 304. The first and fifth layers 301, 305 serve as cover or boundary layers to provide boundaries for microstructures defined in the second and fourth layers 302, 304. The second layer 302 defines an actuating region 310, which may be a channel or chamber. The third layer 303 is composed of a deformable membrane that can deform into the actuating region 310 under certain conditions, such as application of a pressure differential across the membrane. One example of such a deformable material includes 0.8 mil (20 microns) thick polypropylene film (RL5000800600500′-850H, Plastic Suppliers, Columbus, Ohio), although other deformable membrane materials may be used. The fourth layer 304 defines two fluidic channels 311, 313 that are separated by a barrier 312 disposed below the actuating region 310.

Preferably, the second and fourth layers 302, 304 of the barrier valve 300 are constructed from double-sided self-adhesive tape materials (e.g., FT 445, Avery Dennison, Pasadena), with the remaining layers 301, 303, 305 constructed from non-adhesive films. As discussed previously, and adhesion-preventing substance is preferably locally applied to either the upper surface 312A of the barrier 312 or to the lower surface 303A of the deformable membrane 303. Such a substance prevents the deformable membrane 303 from bonding to the barrier 312.

In a first operating state illustrated in FIG. 4A, the valve 300 is closed. This may be accomplished, for example, by applying a pressurized fluid such as compressed air or nitrogen to the actuating chamber 310. This prevents fluid flow from channel 311 to channel 313, as shown schematically in FIG. 4A.

Applying vacuum to the actuating chamber 310 causes the valve to open, as shown in FIG. 4B. The pressure differential lifts the membrane 303 away from the barrier 312, thus opening a fluid flow path from the first fluidic channel 311 over the barrier 312 and into the second fluidic channel 313. This fluid flow path will remain open as long as vacuum is applied.

The particular devices and construction methods illustrated and described herein are provided by way of example only, and are not intended to limit the scope of the invention. It will be apparent that certain changes and modifications may be practiced within the scope of the invention, which should be restricted only in accordance with the appended claims and their equivalents.

What is claimed is:

1. A substantially sealed microfluidic device for performing pipettorless ratiometric dilution, the device comprising:
a first chamber defining a first discrete volume;
a second chamber defining a second discrete volume;
a third chamber defining a third discrete volume;
a first valve disposed between and permitting selective fluid communication between the first chamber and the second chamber;
a second valve disposed between and permitting selective fluid communication between the second chamber and the third chamber; and
a sample inlet port in selective fluid communication with any of the first, second, or third chamber.

2. The device of claim 1, further comprising a diluent inlet port in selective fluid communication with any of the first, second, or third chamber.

3. The device of claim 1 wherein the device is pressure-driven.

4. The device of claim 1 wherein the device is non-electrokinetic.

5. The device of claim 1 wherein any of the first, second, and third chamber is bounded along at least one surface by a deformable membrane.

6. The device of claim 1 wherein any of the first, second, and third chamber is bounded along at least one surface by a substantially optically transmissive material.

7. The device of claim 1, further comprising:
first mixing means in fluid communication with the second chamber, and
second mixing means in fluid communication with the third chamber.

8. The device of claim 7 wherein any of the first mixing means and the second mixing means includes a contraction region and a mixing channel.

9. The device of claim 7 wherein any of the first mixing means and the second mixing means includes a ferromagnetic or paramagnetic element.

10. The device of claim 7 wherein any of the first mixing means and the second mixing means includes a sonicator.

11. The device of claim 7 wherein the mixing means includes at least one first mixing channel associated with the second chamber, and at least one second mixing channel associated with the third chamber, the device further comprising:
a third valve disposed between the second chamber and the first mixing channel; and
a fourth valve disposed between the third chamber and the second mixing channel.

12. The device of claim 1 wherein the first discrete volume, the second discrete volume, and the third discrete volume are substantially equal.

13. The microfluidic device of claim 1 wherein any of the first discrete volume, the second discrete volume, and the third discrete volume is less than or equal to about one microliter.

14. The device of claim 1 wherein the device comprises a plurality of laminated device layers including a plurality of stencil layers.

15. The device of claim 14 wherein a device layer of the plurality of laminated device layers comprises a gas-permeable porous material.

16. The device of claim 14 wherein the first chamber and the second chamber are defined through the entire thickness of one stencil layer of the plurality of stencil layers.

17. The device of claim 1, further comprising a plurality of valve actuation ports.

18. The microfluidic device of claim 1 wherein the first, second, and third chamber are sized, shaped, and positioned to conform to wells arrayed in a standard ninety-six, three hundred eighty-four, or fifteen hundred thirty-six well plate format.

19. A substantially sealed microfluidic device for pipettorless ratiometric dilution, the device comprising:
a first fluidic inlet port;
a mixing chamber in selective fluid communication with the fluidic inlet port;
a first receiving chamber in selective fluid communication with the mixing chamber;
a second receiving chamber in selective fluid communication with the mixing chamber; and
a third receiving chamber in selective fluid communication with the mixing chamber;
wherein the mixing chamber has a mixing chamber volume, the first receiving chamber has a first volume, the second receiving chamber has a second volume, and the third receiving chamber has a third volume, and the mixing chamber volume is greater than any of the first volume, second volume, and the third volume.

20. The device of claim 19 wherein the device is pressure-driven.

21. The device of claim 19 wherein the device is non-electrokinetic.

22. The device of claim 19, further comprising:
a channel network and a channel junction permitting fluid communication between the mixing chamber and the first, second, and third receiving chamber.

23. The device of claim 19, further comprising fluid mixing means.

24. The device of claim 23 wherein the mixing means includes a ferromagnetic or paramagnetic element.

25. The device of claim 23 wherein the mixing means includes a sonicator.

26. The device of claim 19, further comprising:
a first valve disposed between the mixing chamber and the first receiving chamber;
a second valve disposed between the mixing chamber and the second receiving chamber; and
a third valve disposed between the mixing chamber and the third receiving chamber.

27. The device of claim 19 wherein any of the first, second, and third chamber is bounded along at least one surface by a substantially optically transmissive material.

28. The device of claim 19 wherein any of the first, second, and third chamber is bounded along at least one surface by a deformable membrane.

29. The device of claim 19 wherein the first volume, second volume, and third volume are substantially equal.

30. The device of claim 19 wherein any of the first volume, second volume, and third volume is less than or equal to about one microliter.

31. The device of claim 19 wherein the device comprises a plurality of laminated device layers including a plurality of stencil layers.

32. The device of claim 31 wherein a device layer of the plurality of laminated device layers comprises a gas-permeable porous material.

33. The device of claim 31 wherein the first chamber and the second chamber are defined through the entire thickness of one stencil layer of the plurality of stencil layers.

34. The device of claim 19, further comprising a plurality of valve actuation ports.

35. A system for performing pipettorless ratiometric dilution in a microfluidic device, the system comprising:
a microfluidic device having a plurality of microfluidic chambers and a plurality of valves;
a first sample source in fluid communication with at least one chamber of the plurality of chambers;
a diluent source in fluid communication with at least one chamber of the plurality of chambers;
valve actuation means in sensory communication with the plurality of valves; and
a material transport system for transporting sample, diluent, and combinations thereof within the device.

36. The system of claim 35, further comprising mixing means in fluid or sensory communication with at least one chamber of the plurality of chambers.

37. The system of claim 35 wherein the material transport system is non-electrokinetic.

38. The system of claim 35 wherein the material transport system comprises at least one of a pressure source and a vacuum source.

39. The system of claim 35, further comprising a detector in sensory communication with at least one chamber of the plurality of chambers.

40. The system of claim 35 wherein the detector is an optical detector.

41. The system of claim 35, further comprising a controller in sensory communication with the valve actuation means and material transport system.

42. A non-electrokinetic microfluidic system for mixing a discrete volumes of a plurality of liquids, the system comprising:
a first microfluidic chamber and a second microfluidic chamber being in at least intermittent fluid communication;
a first microfluidic channel disposed between the first microfluidic chamber and the second microfluidic chamber;
a second microfluidic channel in fluid communication with first microfluidic chamber; and
a reversible fluid transport system in fluid communication with the second microfluidic channel.

43. The system of claim 42, further comprising a third microfluidic channel in fluid communication with second microfluidic chamber, wherein the reversible fluid transport system is in fluid communication with the third microfluidic channel.

44. The system of claim 42, further comprising a gas-permeable porous material in fluid communication with the second microfluidic channel.

45. The system of claim 42 wherein the reversible fluid transport system comprises a reversible pump.

46. A method for performing pipettorless ratiometric dilution in a microfluidic device, the method comprising the steps of:
providing a microfluidic device having a plurality of chambers and a plurality of valves;
substantially filling a first chamber of the plurality of chambers with a sample;
substantially filling a series of chambers of the plurality of chambers with diluent;
establishing fluid communication between the first chamber and a second chamber of the series of chambers;
mixing the contents of the first chamber and the second chamber to form a first mixture;
isolating at least two portions of the first mixture;
establishing fluid communication between the second chamber and a third chamber of the series of chambers; and
mixing the contents of the second chamber and the third chamber to form a second mixture.

47. A method for performing pipettorless ratiometric dilution in a microfluidic device, the method comprising the steps of:
providing a microfluidic device having a mixing chamber, a plurality of receiving chambers in selective fluid communication with the mixing chamber, and a plurality of valves;
substantially filling the mixing chamber with a sample;
establishing fluid communication between the mixing chamber and a first receiving chamber, of the plurality of receiving chambers;
supplying diluent to the mixing chamber, thus displacing a portion of the contents of the mixing chamber into the first receiving chamber;
mixing the contents of the mixing chamber;
establishing fluid communication between the mixing chamber and a second receiving chamber of the plurality of receiving chambers;
supplying diluent to the mixing chamber, thus displacing a portion of the contents of the mixing chamber into the second receiving chamber; and
mixing the contents of the mixing chamber.
